(19) United States
(12) Patent Application Publication
(10) Pub. No.: US 2003/0070627 A1
(43) Pub. Date: Apr. 17, 2003

(54) Direct contact evaporator replacement

(76) Inventors: Eugene Sullivan, Mobile, AL (US); Daniel R. Higgins, Tigard, OR (US); Robert B. Hill, Beaverton, OR (US); Russ Andrews, Mobile, AL (US)

Correspondence Address: DELLETT AND WALTERS, 310 S.W. FOURTH AVENUE, SUITE 1101, PORTLAND, OR, 97204, US

(21) Appl. No.: 10/244,091

(22) Filed: Sep. 12, 2002

Related U.S. Application Data
(60) Provisional application No. 60/324,036, filed on Sep. 20, 2001.
(60) Provisional application No. 60/329,066, filed on Oct. 12, 2001.

(51) Int. Cl. F22D 1/00; F22B 1/02; F22B 7/00; F22B 31/02; F16T 1/00; F22B 37/26; F02M 51/00

(52) U.S. Cl. 122/135.1; 122/155.1; 122/488; 122/34; 122/7 R

(57) ABSTRACT

An indirect black liquor concentrator uses recirculating flow black liquor through a heat exchangers, employing flue gas for heat. The heated liquor is flashed, to provide steam and concentrate the liquor.

### BACKGROUND OF THE INVENTION

This invention relates to recovery boilers, and more particularly the replacement of direct contact evaporator systems and black liquor oxidation systems.

In recovery boilers direct contact evaporators are employed to evaporate water in the liquor. For example, in FIG. 1, a cyclone evaporator is shown. In the evaporator of FIG. 1, flue gas from the recovery boiler is introduced into a cyclone evaporator, and liquor is sprayed in. The hot flue gas evaporates water from the liquor. The evaporated water is then carried out with the flue gas, while concentrated liquor is removed from the bottom of the evaporator tank, by the liquor recirculation pumps. Typically, before evaporation, the liquor is approximately 50% solid, while after evaporation, the liquor will be 65% to 75% solids.

These systems are called direct contact evaporators because the flue gas contacts the liquor. Their overall goal is to concentrate liquor, lower flue gas temperatures, and act as a particulate trap. However, because the flue gas contacts the liquor, it will strip off pollutants from the liquor, such as SO₂, H₂S, methyl mercaptan, etc., and these pollutants, often characterized as total reduced sulfur (TRS), are carried out with the flue gas and exhausted to the atmosphere. To reduce pollutants, environmental regulations will limit the amount of TRS allowed. New recovery boilers may have a limit of 5 parts/million TRS, while older recovery boilers may be allowed to operate under older higher limits of 15-20 parts/million TRS.

While the older boilers continue to be operational, they operate under the higher limits. However replacement of the boiler, or even repair or replacement of parts thereof, may bring the boiler under newer, lower limit TRS regulations. As such, recovery boiler operators may be reluctant or cautious when considering whether to add improvements to the existing boiler, since a relatively small change or addition to the boiler can result in the system being required to be upgraded to qualify under the lower limit TRS regulations. Such upgrading can be prohibitively expensive.

To reduce hazardous air pollutants (HAP) from direct contact evaporators, black liquor oxidation systems (BLOX) are commonly employed, where atmospheric air is sparged or bubbled through black liquor, which oxidizes the various compounds in the liquor before it contact the flue gas and the direct contact evaporator. For example, NA₂S in the flue gas will be converted to sodium thiosulfate, when then converts to NA₂SO₄. However, these BLOX systems are expensive to operate, having very large horsepower requirements to sparge the air through the black liquor. Some systems use injected oxygen, to increase the oxidation capabilities. These oxygen systems can also be expensive to operate.

### SUMMARY OF THE INVENTION

In accordance with the invention, the direct contact evaporator and black liquor oxidation systems are replaced with an indirect contact heat exchanger having black liquor pumped therethrough. Flue gas is cooled by the heat exchanger, which heats the black liquor. The heated black liquor is sent to a flash tank via a shockwave power generator or a high shear mixer, and in the flash tank, the black liquor boils, releasing steam and concentrating the liquor.

Accordingly, it is an object of the present invention to provide an improved system and method that replaces direct contact evaporators.

It is a further object of the present invention to provide an improved system and method to replace black liquor oxidation systems.

It is yet another object of the present invention to provide an improved system and method for concentrating black liquor while minimizing pollutants.

Another object of the present invention is to provide and improved and method to concentrate black liquor using furnace flue gas as a heat source

Another object of the present invention is to provide and improved system and method to replace the direct contact evaporator requiring substantially less capital than previous remedies.

Another object of the present invention is to provide and improved system and method reduce pollutant emissions from recovery boilers and associated equipment.

Another object of the present invention is to provide and improved system and method reduce pollutant emissions from recovery boilers and associated equipment, while operating at lower cost.

Another object of the present invention is to provide and improved system and method to reduce pollutant emissions from recovery boilers requiring substantially less capital than previous remedies.

Another object of the present invention is to provide and improved system and method to trim black liquor solids and/or temperature.

A further object of the present invention is to provide and improved system and method to concentrate liquor, lower flue gas temperatures, and act as a particulate trap.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a diagram of a cyclone style direct contact evaporator;

FIG. 2 is a block diagram of a replacement for direct contact evaporator and black liquor oxidation systems, in accordance with the invention.

FIG. 3 is a schematic side view of a cascade evaporator according to the prior art;

FIG. 4 is a schematic side view of a heat exchanger according to the present invention;

FIG. 5 is a representative view of heat exchanger tubes to illustrate spacing thereof; and

FIG. 6 is a view illustrating soot blower configuration according to the invention.

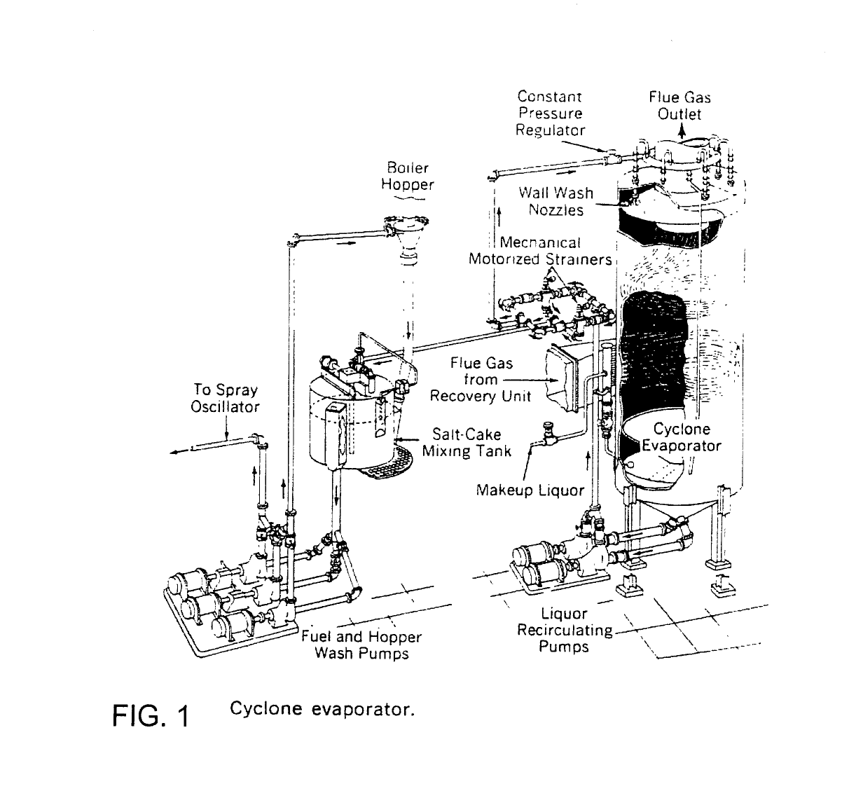

### DETAILED DESCRIPTION

The system according to a preferred embodiment of the present invention comprises a system for concentrating recovery boiler liquor.

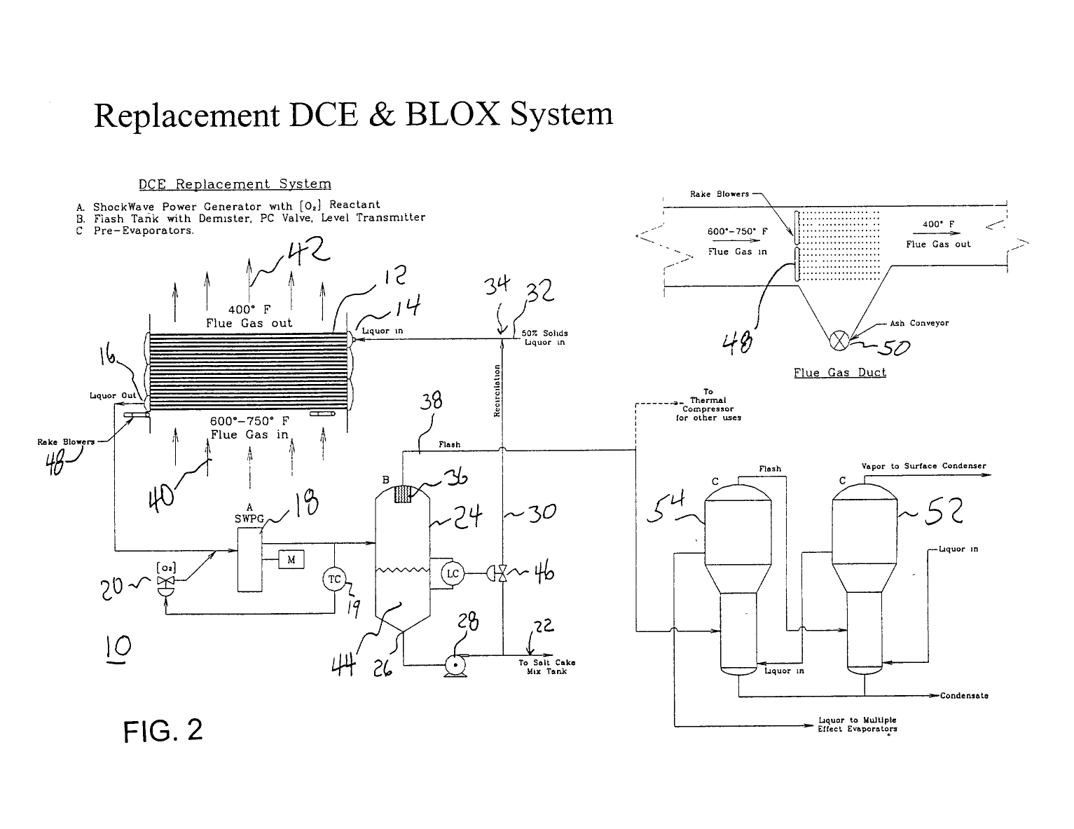

Referring to FIG. 2, a block diagram of a replacement for direct contact evaporator and black liquor (BL) oxidation systems, the system 10 comprises a cross flow heat exchanger 12, which receives incoming liquor via liquor inlet 14. The heat exchanger includes a liquor outlet 16, which connects to a high shear mixer 18 (SWPG) driven by motor M, or other mixer technology. Temperature control 19 is provided at the output side of the SWPG, to sense the temperature, and provides a control line to an oxygen injection system 20. An oxygen reactant may be provided by the oxygen injection system 20. The output of the SWPG is conveyed to a flash tank 24, which has a concentrated liquor output 26 at the bottom thereof via a pump 28. The output of pump 28 is provided to a salt cake mix tank (not shown) and is also provided via recirculation line 30 to the liquor inlet 14 of the heat exchanger 12. The recirculation line 30 combines with a liquor input line 32 at point 34, prior to being provided to the liquor inlet 14.

The upper end of flash tank 24 includes a de-mister 36, which provides output to flash line 38.

In operation, hot flue gas 40, typically being 600°-750° F., is passed into the heat exchanger 12, and exits as cooler gas 42, typically being cooled to approximately 400° F. The liquor is being constantly circulated through the heat exchanger at, for example, 4 or 5 times the rate at which concentrated liquor is extracted to the salt cake tank. As the liquor leaves the heat exchanger, it enters the shockwave power generator, which may or may not add oxygen to adjust the temperature of the liquor, whereupon the liquor will enter the flash tank, releasing steam. The steam, de-misted by de-mister 36, is then supplied via flash line 38 for other uses, discussed hereinbelow.

The liquor, by boiling and releasing steam, thereby forms concentrated liquor 44 in the bottom of the flash tank, and may be drawn out by pump 28 to the salt cake mix tank, and, via recirculation line 30, back through the heat exchanger. The flash tank includes a level transmitter in level control 25, so the liquor level may be monitored and the level in the tank may be controlled, by reducing the amount of recirculation of concentrated liquor via valve 46 (in line 30). In addition to the recirculation of the concentrated liquor, unconcentrated liquor (e.g. 50% solids liquor) is input to the heat exchanger, mixing with the recirculated concentrated liquor.

The heat exchanger is also provided with rake blowers 48, which are operated occasionally, the clean the heat exchanger tubes. The rake blowers typically provide steam jets or the like to clean the external surfaces of the tubes of the heat exchanger, to remove collected material thereon. (The operation of the boiler creates deposits which coat the heat exchange surfaces. The rake blowers remove these deposits by directing cleaning jets of air, steam or water onto heat exchange surfaces, to maximize thermal efficiency). For the rake blowers, improved rake blowers with contoured full expansion (CFE) nozzles available through Clyde Blowers, Ltd., Glasgow, Scotland, are suitably employed.

Referring to the upper right portion of FIG. 2, which is another partial side view of a flue gas duct within the heat exchanger, the rake blowers will remove ash and the like from the heat exchangers, which is then collected below and removed by an ash conveyer 50. The ash conveyor may comprise a mechanical screw or drag belt, for example.

The flash line 38 is suitably connected so that the steam may be employed for other uses. For example, flash steam can be used in the conventional liquor concentrators or evaporators or as the mode of steam in one or more effects of an existing multi-effect evaporator. In FIG. 2, an example use is to employ the steam in pre-evaporators 52, 54, wherein the flash line 38 is conveyed to pre-evaporator 54. The flash output of evaporator 54 is conveyed to evaporator 52, and vapor off of evaporator 52 is provided to a surface condenser, for example. Liquor prior to concentration is input to evaporator 52, and output liquor therefrom is provided to evaporator 54, which provides output liquor for further use or evaporation. Both evaporators collect condensate which is removed for other use or processing. The condensate at this point may be “foul condensate”, having picked up various pollutants from the liquor, and is suitably returned to a condensate stripper which is in another facility in the mill where the recovery boiler is installed.

While the preferred embodiment employs a cross flow heat exchanger 12, other heat exchangers may suitably be employed. For example, a long flow heat exchanger is also suitably employed. Also, the shockwave power generator may be replaced by a high shear mixer, or other suitably technology.

While the level control for the flash tank is accomplished by variation of the recirculation of concentrated liquor in the illustrated embodiment, other manners of accomplishing this may be employed, and include, for example, reducing or increasing the rate at which concentrated liquor is sent to the salt cake mix tank, increasing the amount of unconcentrated liquor supplied at 32, etc. Any suitable manner may be employed so as to increase or decrease the liquor level in the tank, to maintain a desired level.

Another alternative embodiment employs the shockwave power generator or equivalent system in a different location, positioning it at position 22 of FIG. 2, in the line supplying the concentrated liquor to the salt cake mix tank. The SWPG referred to herein is a high shear mixer or controlled cavitation device or other mixture technology such as Gorator macerator/pump as supplied by GL&V/Dorr-Oliver Inc., 174 West Street South, Orillia, Ontario L3V6L4 Canada, or a high shear mixer is suitably employed. Having the SWPG downstream at position 22, enables control of viscosity downstream, or for further heating value reduction, viscosity reduction, or temperature control.

In accordance with the invention, the flue gas is indirectly heating the liquor, so there is no direct contact, removing the issue of TRS and HAP. Also, the BLOX system is not required, and its attendant operating costs are removed. Further, in a BLOX system, storage tanks are required, and these tanks may now be used for other purposes, if desired.

Thus, the system and methods according to the invention use flue gas as heat source for liquor condensing. The use of the Shockwave power generator or similar technology enables “trim” or final control of the solids content in liquor, either with mechanical energy or mechanical and chemical energy in form of the introduced oxygen (see item 20 FIG. 2). Using the SWPG allows trimming to a solids content or to a temperature.

The use of the liquor concentration system of the invention also allows reduction of the heating value of the black liquor fuel. This can be desirable because it enables burning of more quantity of liquor in a boiler that was designed for a certain heat release, whereas if the liquor had a higher heating value, less of it could be burned in that same boiler.

Further, the system allows lowering the viscosity of the black liquor to allow higher solids liquor to be transported, by improving transport properties of the liquor.

Another embodiment of the invention includes a visible light camera or cameras, optical fiber, or other vision device or means attached to the rake blower to allow an operator to inspect the cleanliness of the heat transfer surfaces.

Another embodiment of the invention employs a heat exchanger having spare passes in the heat exchanger on the liquor side, together with flow shut off valves or means. This enables one or more passages of the exchangers to be cut out and cleaned while rest of system is on line.

Cleaning of the tubes may be accomplished by tube interior cleaning technology such as that produced by Taprogge Corporation, wherein “fuzzy” balls having sandpaper grit & textures are introduced into and circulate through tubes for a period of time to clean the interior tube surfaces. Then, the balls are filtered out later. (TAPROGGE America Corp., 100 Crossways Park West, Woddbury, N.Y. USA 11797).

Further embodiments include the ability to bypass a selected section of the heat exchanger on flue gas side, for example, by use of damper or closing sections, whereby the flue gas sides of the heat exchanger can be cleaned if necessary, without having to take the boiler off line.

The cleaning of the heat exchanger may be accomplished physically by hand cleaning (both flue and liquor side). Sections of the flue gas or liquor side are cut out of operation, so gas or liquor isn't going through those sections anymore. Access is then provided by a door or other closing means, and the portion to be cleaned can be manually rodded, for example.

A further embodiment is provided wherein the system corresponds to the heat exchanger and flash system of FIG. 2, except the black liquor may be flashed multiple times. For example, the black liquor may only goes through ⅕ or ½ of heat exchanger, then through an intermediate flash stage, and then back through another part of exchanger, and so on. This helps prevent liquor burn, and increases the heat capacity available with a give size heat exchanger.

The system & flash steam may be thermo compressed to a higher pressure, and used for sootblowing or other applications that may be suitable for the steam.

On the ash conveying side, another embodiment employs pneumatic conveying technology such as available from Clyde pneumatic conveying for the ash that is removed from the heat exchanger.

The system according to the invention provides the ability to water wash the flue gas side of the heat exchanger either in whole or part while unit is in operation

Still a further embodiment includes using the steam that has been flashed by the flash tank 24, and providing a heat exchanger with a portion that the steam is directed through, separate from flue gas side to recapture heat and put it back into the liquor either in condensing or non-condensing manner.

In an alternative embodiment, a portion of liquor is counter flow in the heat exchanger, and is then flashed. Then, in another portion, the liquor is parallel flow, enabling control of temperature and heat transfer.

Thus, in accordance with the invention, improved systems and methods to concentrate liquor, lower flue gas temperatures, and act as a particulate trap are provided. The system reduces TRS, reduces BLOX operation costs, provides thermal efficiency gain, eliminates the need to clean the direct contact evaporator (DCE), removes DCE safety risk of the liquor catching on fire as a result of direct contact with the hot flue gas (the liquor is the fuel for the boiler). Induced draft (ID) fan (which pulls flue gas out of the boiler) capacity can be increased, because there is less volume because water is no longer going into the flue gas. No longer is significant amount of water vapor being moved. Reduction in corrosion in the back end of the boiler is reduced that in the past resulted from acid build up as a result of the sulfur/water content of the flue gas.

Storage is increased as a result of the BLOX tanks which are not needed (or fewer are needed) freeing the tanks for other use. The boiler is provided with improved combustion stability, as a more consistent concentration is accomplished with the invention, whereas with DCE devices, liquor concentrations tend to vary. The heating value and firing capability of the liquor can increase with the present invention, as a result of higher solids being present. Methanol and TRS stripping from the BLOX are eliminated (since the BLOX is not needed or is less necessary with the present system).

The system of the invention does not affect boiler steaming/water circulation issues, whereas long flow economizers tend to change flow conditions in a boiler. The system is relatively small, and does not require the large space and support structural strength that a long flow economizer would.

Thus, in accordance with a Direct Contact Evaporator & BLOX Elimination System of the invention, equipment and downtime costs are reduced.

Benefits include TRS Reduction, BLOX Operating Cost Reduction, Thermal Efficiency Gain, DCE Cleaning Elimination, DCE Safety Risk, Increased ID Fan Capacity, Reduction in Back end corrosion, Storage Increase, Improved Combustion Stability, Heating value increase, Higher Solids Firing capability, Multiple-Effect evaporation economy, Eliminate Methanol & TRS stripping in BLOX, Liquor spill reduction, and Simplicity improvement in operation. General functions that are desirable for the system are to boost concentration of black liquor approximately 15% to 25+%, cooling of hot flue gases by 250 to 400 degrees F. and dust trap 15% to 30+% carryover. Conversion concerns addressed by the system are boiler age, Reliability of new components/systems, production impacts, boiler steaming/water circulation issues, space/room to add components, structural issues, PSD evaluations (USA), particulate removal, on-line cleaning, and combustion air system.

Costs of a typical approach that might be employed by a boiler vendor (assuming a 1000 tons per day recovery boiler) as set forth below. Such approaches might be to install new concentrators, involving demolition of the DCE and demolition of the BLOX, costing between $5 and $7 million. Also, long flow economizer modification might be employed involving demolition of existing small economizer, superheater additions, circulation modifications, at a cost of $9 to $14 million. Also, precipitator modifications costing $1 to $3 million and downtime costs of $4 to $6 million might be involved, for a total potential cost of $19 to $30 million.

Tangible economics of such a conversion (not-recovery & not production limited mill) might be as follows. Increased steam production, including 5-7% steam flow increase and multi-effect evaporation economy could save $1 million. Lower maintenance cost, including DCE repairs, BLOX repairs, and Precipitator repairs would save $1 million. Fewer production interruptions such as from less DCE cleaning would save $2 million, for a total $4 million savings.

Other miscellaneous cost & benefits include elimination of BLOX high electrical cost, auxiliary fuel reduction due to elimination of DCE cleaning, less spill potential risk, the ability to run higher firing percent solids, lower viscosity and increased ID Fan capacity.

In accordance with the system of the invention, Anthony-Ross Company a replacement DCE system employs new technology for indirect liquor heating with flue gases with significantly lower investment cost estimated at five (5) million $ (+/−25%).

The indirect liquor heating concepts involve replacing DCE with non-fouling indirect flue gas liquor heater system and flash tank, using the existing footprint/space of the DCE system, completely eliminating the BLOX system, reducing liquor temperature fluctuations (from flue gas temperature fluctuations) with SWPG “Boost Concentration System”. Installation is typically completed during normal maintenance outage periods (approximately 8-10 days).

In accordance with an embodiment of the system, product liquor from multi-effect evaporators goes directly to indirect flue gas heat exchanger eliminating need of oxidation. A counter flow indirect heat exchanger has several liquor passes under high velocity (tube side), including re-circulation liquor from the flash tank. The gas side of the heater is cleaned by recovery service (heavy duty) rake blowers. Liquor discharge from heater goes to a SWPG mixer (for example) where oxygen is added to maintain a constant liquor temperature. Not much oxygen is used as the objective is to reduce the liquor temperature fluctuations into the flash tank due from flue gas temperature variations. Ash from the heater hopper is screw fed into the mix tank. The flash tank is designed to handle vapor for concentration boost up to 25%. Vapor runs through a demister and then can be thermo-compressed to 60 psi for the multi-effect evaporator supply steam where it can potentially be expected to supply 50%-to 80% of total steam requirement (depending on existing evaporator economy). Flash steam can also be used for pre-evaporators or other uses if preferred. The level in the flash tank is controlled by the feed liquor into the heater from the multi-effect evaporators. Liquor from the flash tank goes to a salt cake mix tank and also as re-circulation into the heater inlet.

In another embodiment of a replacement for a direct contact evaporator, a multiple stage heat exchange system is employed. In such a system a the flue gas heat exchanger employs some other heat transfer media therein rather than having the black liquor passing through the heat exchanger that is in the flue gas stream. For example, in the preferred embodiment, glycol or Dowtherm heat transfer fluid from The Dow Chemical Company, which are liquids, are used a heat transfer medium in the heat exchanger that the flue gas passes through. Then, in a second heat exchanger, the glycol/Dowtherm are used to transfer the heat to the black liquor. Such a system provides several advantages. First, the heat exchanger components that are in the flue gas flow can be made of carbon steel, for example, rather than stainless steel, which would be required if the black liquor was being passed through the heat exchanger. The glycol/Dowtherm doesn't corrode as the black liquor would. Further, because glycol or some other heat transfer media is used, it is no longer necessary to employ the black liquor recirculation.

The glycol side of the system is suitably pressurized, so that the glycol won't boil.

In the case of the flue gas to black liquor indirect system (as opposed to the flue gas to glycol/glycol to black liquor system), the tube size requirements in the heat exchanger were such that large tubes were needed.

Since the glycol and black liquor are both “liquids”, the heat transfer rate is higher, so a much smaller heat exchanger is required on the glycol to black liquor side. Therefore, while the second heat exchanger needs to be stainless steel, for example, it can be a much smaller heat exchanger than in the case of the flue gas to black liquor embodiment, which reduces the cost.

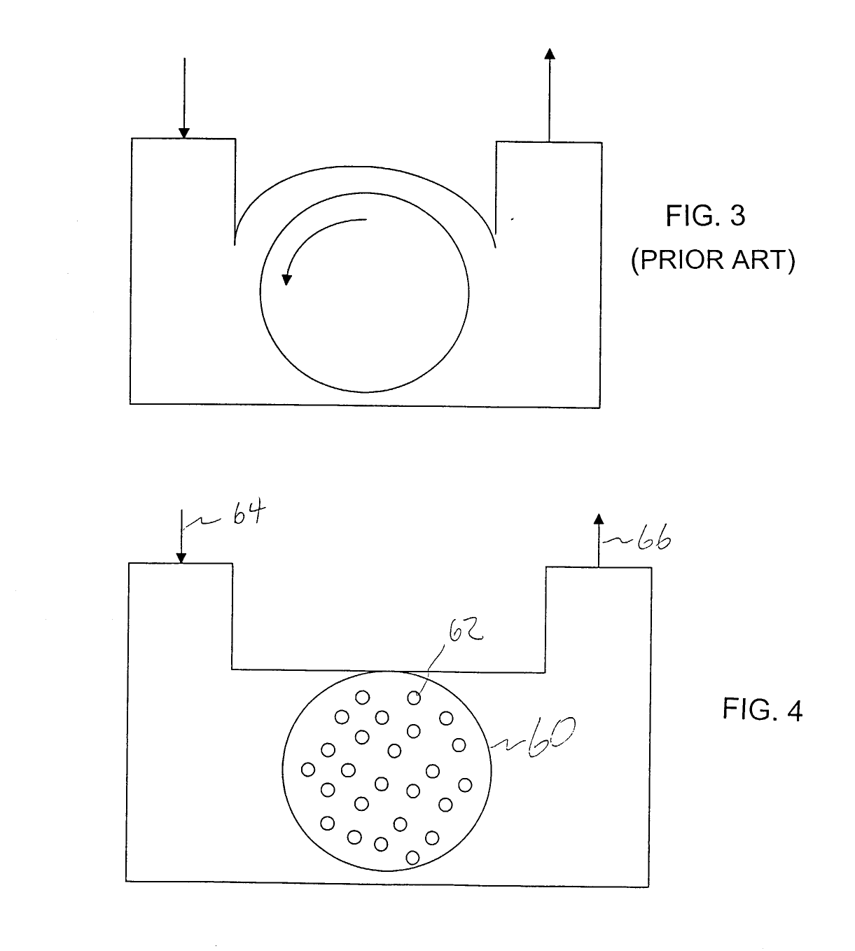

On the flue gas/glycol side of the system, the tube diameters can be smaller than the case where black liquor was traveling through the tubes. Therefore, there is more flexibility as to tube spacing and pitch. The smaller tubes have a larger pitch, which leads to less fouling and easier cleaning with sootblowers or the like. FIG. 4 illustrates the flue gas to glycol side heat exchanger in a schematic side view. The heat exchanger 60 comprises plural tubes 62 through which the glycol passes. The flue gas enters at 64 and exits at 66, passing through the tubes of the heat exchanger. A prior art cascade evaporator is illustrated in FIG. 3. It will be understood that in accordance with the invention, the cascade evaporator may be replaced by the heat exchanger 60.

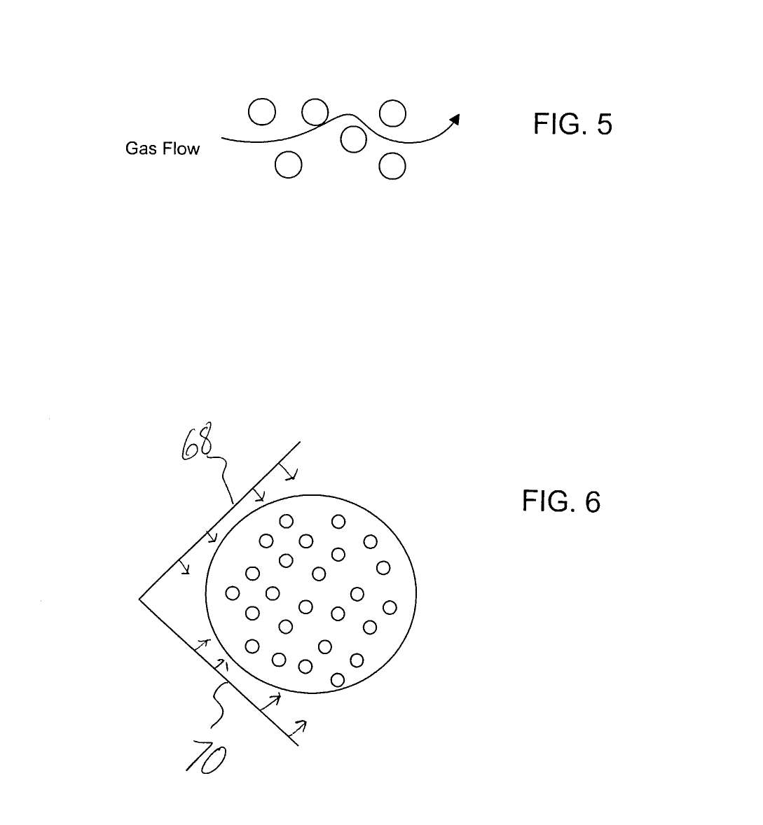

Referring to FIG. 6, in a particular embodiment, two soot blowers (rake blowers) are configured at right angles such that upper blower 68 blows from an upper angle while the lower blower 70 blows from a lower angle relative to the tubes (indicated by arrows). This enables a triangular pitch to the tubes, which is more efficient. An example tube triangular pitch is shown in FIG. 5. The soot blowers can be rake blowers which are adapted to traverse the extent of the heat exchanger tubes in a cleaning cycle.

Still further, for cleaning, since the flue gas/glycol heat exchanger is designed to be installed far “downstream” from the boiler, a water canon type soot blower can be employed to clean. (close to the boiler, water could not be used, since introducing water directly into the boiler could result in an explosive reaction).

In the case of using a water canon soot blower, the water left after cleaning may be collected and treated, or simply allowed to evaporate. Where the water is collected, it can be run through a mixer or SWPG or similar device and concentrated or used as a dilution material in the salt cake tank.

It is desirable to control the solids level in the black liquor. One manner of doing this is to overdry the liquor, and then add the water collected from the cleaning process with the water canon soot blower, to provide the desired solids level. The collected water may suitably be saved in a tank, for example and added back to the liquor over time as needed.

Still further, the collected water can be disposed of via the foul condensate collection system of the boiler.

Further embodiments of the heat exchanger of FIG. 4 include flue gas bypass options, so that depending on the amount of heat in the flue gas, some flue gas can bypass the heat exchangers (if for example, the gas is transferring too much heat to the exchanger). IR or other sensors are employable to monitor the heat, and adjustment to flow can be accomplished under automatic (e.g. computer) or manual control. Alternatively, multiple heat exchanger banks can be provided, and those banks may be switched in or out to control the amount of heat extracted.

The flow of the liquor is monitorable and may be controlled and adjusted for optimal operation of the system, so that the concentration does not drop below a certain set point.

The tubes of the heat exchangers can be monitored for temperature, which will indicated when tube fouling is taking place (based on the change in the heat transfer being accomplished). Thus, an operator or an automated system can be notified of the fouling so that cleaning or other corrective action can be taken.

The glycol is suitably pumped through the tubes of the heat exchangers. However, in an alternative embodiment, thermal siphoning is used in place of pumping.

Thus, according to the invention, a direct contact evaporator replacement is provided that requires no modification to the boiler circulation circuits. The water side of the boiler is left intact. The air side is substantially unchanged, too. The existing economizer is useable. Installation of the system can be accomplished with minimal outages. It can be installed during a normal maintenance outage. The system can be prefabricated, and simply put in place at the time of installation. The system fits within the existing footprint of the direct contact evaporator that it is replacing. Thus, no new “real estate” within the boiler is required. No new building structure is required to accommodate the system. The system is such that repermitting is likely avoided, and the installation is unlikely to have an impact relative to boiler insurance issues, because the existing steam system load is not being affected.

The system provides a significant heat exchange improvement over long flow economizers, and solves fouling challenges that occur when trying to minimize size of heat exchangers (the system allows tube spacing and configuration that minimizes fouling problems that occur with tightly space heat exchanger tubes).

The system reduces corrosion in the precipitator because the water in the downstream flue gas is eliminated that would be present with a direct contact evaporator.

According to the invention, the black liquor side of the heat exchange system can be constructed with 2 or more exchangers or portions, wherein one or more of the exchangers can be taken offline or out of service for cleaning, while the other exchangers are still functioning. Thus, it is possible to clean the exchangers while the boiler is online.

In the embodiment using flue gas to glycol and glycol to black liquor heat transfer, the black liquor side may be controlled by blending process with unprocessed liquor to control the heat transfer. For example, in a single flashing system (one flash stage), the concentration out of the flash tank might be 70%, while the raw unprocessed liquor concentration is 50%. A portion of the concentrated liquor is mixed in with the unprocessed to raise the concentration going into the heat exchanger, to 66%, for example.

In the case of a double flash stage, feedback from either the first or second flash tank output (or both) may be supplied to mix with the unprocessed liquor.

According to the invention, heat from the flue gas is extracted and used to evaporate the black liquor.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A recovery boiler, comprising,
a liquor concentrator system, wherein said system employs flue gas as heat source for liquor.

2. A system for use in a recovery boiler according to claim 1, comprising a shockwave power generator or similar technology to trim or do final control of solids content in liquor.

3. The system according to claim 2, employing either with mechanical energy or mechanical and chemical energy in form of introduced oxygen.

4. The system according to claim 2, wherein control of said trim is based on a solids content.

5. The system according to claim 2, wherein control of said trim is based on a temperature.

6. A heat exchanger for use in a recovery boiler, comprising:
at least one rake blower;
a vision device attached to said rake blower to enable inspection of cleanliness of heat transfer surfaces in said heat exchanger.

7. A heat exchanger for use in a recovery boiler, comprising:
spare passages in the heat exchanger whereby one or more passages can be cut out and cleaned while rest of system is on line.

8. A liquor concentrator, comprising:
a flue gas heat exchanger for obtaining heat from flue gas for employing in concentrating liquor; and
a recirculation system for recirculating liquor.

9. A heat exchanger for use in a recovery boiler, comprising:
means to bypass selected sections of the heat exchanger on flue gas side, to enable cleaning while online.

10. A black liquor concentrator, comprising:
a heat exchanger for recovering heat from flue gas and heating black liquor;
a flash system for flashing said black liquor to enable steam to escape therefrom.

11. A black liquor concentrator according to claim 10, wherein said flash system comprises and intermediate flash stage for a first flashing, whereupon the black liquor goes through another part of exchanger thereafter.

12. A black liquor concentrator according to claim 10, further comprising a system to compress said steam to a higher pressure.

13. A black liquor concentrator according to claim 10, further comprising a recirculation system, employed as level control means in flash tank.

14. A black liquor concentrator according to claim 10, further comprising a mixer employed to control viscosity downstream, or for further heating value reduction, viscosity reduction, or temperature control.

15. A black liquor concentrator according to claim 10, further comprising using said across a portion of the heat exchanger separate from flue gas side to recapture heat and put back into liquor either in condensing or non-condensing manner.

16. The system according to claim 10, wherein liquor in said heat exchanger is cross flow.

17. The system according to claims 10, wherein liquor in said heat exchanger is long flow.

18. The system according to claims 10, wherein at least a portion of liquor in said heat exchanger is counter flow.

19. The system according to claim 20, wherein after liquor in said heat exchanger is cross flow, it is then flashed.

20. The system according to claim 19, wherein after liquor is flashed, it is supplied to a heat exchanger in parallel/concurrent flow.

21. A system for concentrating black liquor comprising:
extracting heat from the flue gas of a boiler;
using said extracted heat to concentrate the black liquor.

22. The system according to claim 21, wherein said flue gas is not in direct contact with the black liquor.
